(19) United States
(12) Patent Application Publication
(10) Pub. No.: US 2007/0101060 A1
(43) Pub. Date: May 3, 2007

(54) Portable memory device

(76) Inventors: Robert J. Robinson, Jamison, PA (US); George Ming Fai Chan, Hong Kong (HK); Christian A. Onetto, Santiago (CL)

Correspondence Address: ROBERTS & ROBERTS, LLP;ATTORNEYS AT LAW, P.O. BOX 484, PRINCETON, NJ, 08542-0484, US

(21) Appl. No.: 11/496,061

(22) Filed: Jul. 28, 2006

Related U.S. Application Data
(60) Provisional application No. 60/727,781, filed on Oct. 18, 2005.

(51) Int. Cl. G06F 12/00

(52) U.S. Cl. 711/115

(57) ABSTRACT

A portable memory devices which is connectable with a computer. The memory device has a display and suitable controls for scrolling through a list of file names within the memory or within an optional memory card attached to the memory device. This allows the user to see the names, files sizes, data types, etc. of the files on the memory device and/or the optionally attached memory card.

### CROSS REFERENCE TO RELATED APPLICATION

This application claims the benefit of U.S. provisional patent application Ser. No. 60/727,781 filed Oct. 18, 2006, which is incorporated herein by reference.

### BACKGROUND OF THE INVENTION

1. Field of the Invention

The invention relates to portable memory devices. More particularly, the invention relates to portable memory devices which are connectable with a computer and wherein the memory device has a visual display and suitable controls for scrolling through a list of directories, sub-directories and file names within the memory or within an optional memory card attached to the memory device. This allows the user to see such information as the names, sizes, data types, etc. of the directories, sub-directories and files on the memory device and/or the optionally attached memory card.

2. Description of the Related Art

Portable data memory devices, or memory sticks, which connect with a personal computer are well known. Typically they are plugged into a universal serial bus (USB) port or other port of a personal computer, laptop computer, personal digital assistant (PDAs), calculator, data organizer, and the like. Typical USB memory devices are known from U.S. Pat. Nos. 6,763,410 and 6,612,853, among others.

They typically include a USB port for data input and a memory for data storage. A problem with such data storage devices is that it is not possible to identify the directories, sub-directories, files and file attributes stored on the device unless they are loaded onto a computer. It would therefore be desirable to provide a portable memory device of the type which is convenient for users to carry anywhere, at any time and also has a controllable display screen, such as an LCD display which allows the user to see and scroll through the directories, sub-directories and file names and other file attributes of the files on the memory device. Optionally the memory device can also have an additional attachment interface for connection to a memory card. In this case, the memory device would also allow an identification of the directories, sub-directories, files and file attributes on the memory card. The memory card can either derive power from a host appliance such as a computer, PDA, etc., or it may have its own memory source such as a battery, fuel cell, or the like. The screen may also have a backlit screen to ease viewing in a dark setting. Preferably the device has a dust cap to keep the interface port clean, as well as a key chain or lanyard.

The device includes a housing which contains internal electronic components such as a controller or other microprocessor coupled to a data memory or memory card. These internal components are electronically coupled to external electronic components of the housing such as an input arrangement for entering alphanumeric data into the data memory or memory card via a computer, and a display, for displaying such data recalled from the data memory. The device may also include a backlight for illuminating the display. The invention preferably includes a key chain attachment implement for attaching keys and the like to the housing.

### SUMMARY OF THE INVENTION

The invention provides a portable memory device comprising:

a) a housing;

b) a display on the housing, capable of exhibiting a changeable array of directories, sub-directories and file names in the form of symbols and alphanumeric characters;

c) an optional non-volatile flash memory within the housing capable of storing digital information in files having directories, sub-directories and file names associated therewith;

d) an attachment interface to enable communication with at least one host appliance;

e) an optional additional attachment interface for connection to a memory card;

f) a controller for exhibiting on the display one or more of the directories, sub-directories and file names within the optional non-volatile flash memory, or within a memory card attached to the optional additional attachment interface;

g) at least one switch on the housing for scrolling through a list of directories, sub-directories and file names within the optional memory or within a memory card attached to the optional additional attachment interface; and wherein at least one of the non-volatile flash memory and the additional attachment interface is present; and

h) a rechargeable battery electrically connecting the display with the controller.

The invention further provides a method for identifying the file names in a portable memory device which comprises:

I.) providing a portable memory device comprising:

a) a housing;

b) a display on the housing, capable of exhibiting a changeable array of directories, sub-directories and file names in the form of symbols and alphanumeric characters;

c) an optional non-volatile flash memory within the housing capable of storing digital information in files having directories, sub-directories and file names associated therewith;

d) an attachment interface to enable communication with at least one host appliance;

e) an optional additional attachment interface for connection to a memory card;

f) a controller for exhibiting on the display one or more of the directories, sub-directories and file names within the optional non-volatile flash memory, or within a memory card attached to the optional additional attachment interface;

g) at least one switch on the housing for scrolling through a list of directories, sub-directories and file names within the optional memory or within a memory card attached to the optional additional attachment interface; and wherein at least one of the non-volatile flash memory and the additional attachment interface is present; and

h) a rechargeable battery electrically connecting the display with the controller; and

II) observing the display while scrolling through a list of file names within the memory or within a memory card optionally attached to the additional attachment interface with the at least one switch on the housing.

### BRIEF DESCRIPTION OF THE DRAWINGS

FIG. 1 shows one embodiment of a portable memory device in the form of a memory stick having a USB connector with a dust cap, an alphanumeric display, and scroll buttons.

FIG. 2 shows the portable memory device of FIG. 1 with a hinged dust cap.

FIG. 3 shows the portable memory device of FIG. 1 with an optional memory card.

FIG. 4 shows as portable memory device of FIG. 1 with an optional memory card, a fold out USB connector, and side controlling scroll buttons.

FIG. 5 shows a side view of the side controlling scroll buttons on the embodiment of FIG. 4.

FIG. 6 shows another embodiment of a portable memory device having a retractable USB connector.

FIG. 7 shows the portable memory device of FIG. 6 with a retractable USB connector in the extended position.

### DETAILED DESCRIPTION OF THE PREFERRED EMBODIMENT

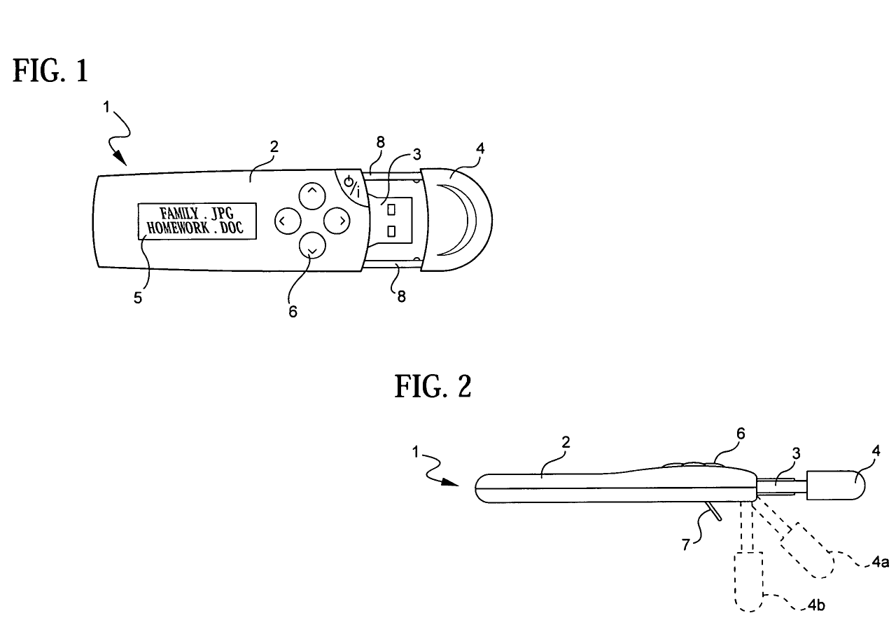

FIGS. 1 and 2 show one embodiment of a portable memory device in the form of a memory stick 1 having a housing 2, a USB connector 3, a dust cap 4, a two-line alphanumeric display 5, and scroll buttons 6. The housing 1 serves as a protective structure for encasing the other components of the device. The housing 2 and dust cap 4 may comprise plastic, metal, rubber, and the like or combinations thereof, or any other material which one skilled in the art may deem suitable for forming a protective structure. In a preferred embodiment, the housing comprises a plastic. The housing 2 is preferably formed into a compact pocket sized or key chain sized shape, which can comfortably fit into a user's hand or pocket.

As shown in FIG. 2, the dust cap 4 may be mounted on a hinge to allow it to be positioned out of the way so that USB connector 3 can be inserted into a host device such as a computer (not shown). FIG. 2 shows dust cap 4 in pivoted positions 4a and 4b when it is desired to move the dust cap out of the way of the USB connector. Door 7 may facilitate hinging of the dust cap. The dust cap 4 may be slidably mounted on struts 8 so that the cap can cover the USB connector when it is not in use. USB connector 3 is itself well known in the art and is a connector adapted for electric connection to a host appliance such as a personal computer. Display 5 can be a well-known LCD display for affording a visual representation of the directories, sub-directories, file names and file attributes on a memory or attached memory card in the form of symbols and alphanumeric characters. File attributes non-exclusively include file size, file type, date and time of creation, etc. Scroll buttons 6 allow control of an internal memory or external memory card and display screen to sequentially, i.e. up, down, left, right, show the file names and other file attributes of the directories, sub-directories and files maintained in the memory or memory card.

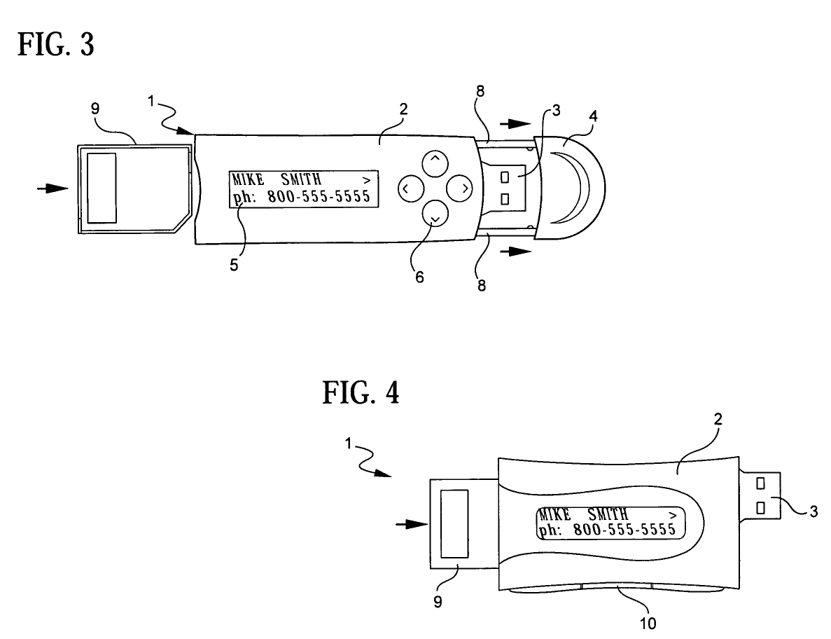

FIG. 3 shows an alternate embodiment of the portable memory device wherein an optional memory card 9 may be inserted into a slot in a side portion of the housing 2. This embodiment allows the user to see the file attributes, i.e. directories, sub-directories, file names, sizes, data types, etc. of the files on the memory device and the optionally attached memory card.

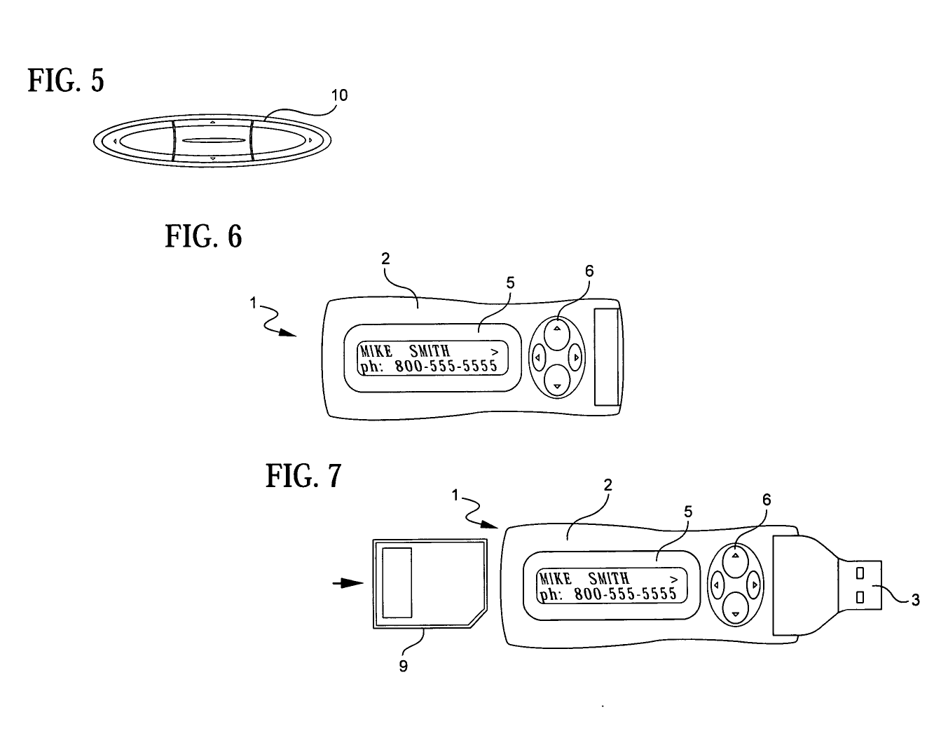

FIGS. 4 and 5 show another alternate embodiment wherein the portable memory device includes a USB connector 3 which is hinged for storage within housing 2 when not in use. This version has scroll buttons 10 on a side edge of housing 2.

FIGS. 6 and 7 show another embodiment of a portable memory device having a USB connector which retracts. FIG. 7 shows the portable memory device of FIG. 6 wherein USB connector 3 is retracted into housing 2 when not in use.

Encased in the housing 2 is an optional non-volatile flash memory within the housing capable of storing digital information in directories, sub-directories and files having file names associated therewith. An attachment interface, i.e., a USB connector, 3 allows the memory to communicate with a host appliance such as a personal computer, laptop computer, personal digital assistant (PDAs), calculator, data organizer, and the like. In one embodiment of the invention, attached to the optional internal memory is an optional additional attachment interface for connection to a memory card. At least one of the internal memory and additional attachment interface must be present in the inventive memory device. A controller such as a microprocessor, masked ROM, or the like, which are well known in the art, facilitates exhibiting on the display one or more of the directories, sub-directories and file names within the memory, or within a memory card optionally attached to the additional attachment interface via an internal controller. The controller facilitates exhibiting on the display one or more of the directories, sub-directories, file names and file attributes within the optional non-volatile flash memory, or within a memory card attached to the optional additional attachment interface. The controller handles data management, communicates the file allocation table and data from the memory to the host appliance, and signals the alphanumeric characters and symbols to the display. The switches 6 on the housing allow scrolling through a list of file names within the memory or within a memory card optionally attached to the additional attachment interface.

The memory and memory card are capable of receiving and storing data such as alphanumeric data. Such data memories are well known in the art. The host appliance, allows entering file data into the memory. The memory is electrically coupled via suitable wires to display 5 which is capable of visually displaying alphanumeric data recalled from the memory via the internal controller. The display may comprise any known conventional means for visually displaying data, such as a black and white or color screen. In a most preferred embodiment, the display comprises a liquid crystal display (LCD). Such displays are well known in the art. The portable memory device is usually powered by the host appliance, but it may also be powered by a rechargeable battery or micro-fuel cell. In a preferred embodiment, the portable memory device further has battery charging circuitry electrically connecting the battery with the attachment interface. Such battery charging circuitry is well known in the art. Typically, the battery is recharged by the host computer through the USB port.

In use, by appropriately engaging the buttons, the portable memory device displays to users the directory names and their associated file names and the attributes of each file name stored in the device independently without a required connecting to any computer or other host device. The portable memory device is similar to any other data storage device when it is connected to a computer. When connected to a computer, the device is controlled by the computer. To effectively read, write, erase or manage the device, a computer will create a file allocation table (FAT) by requesting the user to format the device if a FAT does not exist. If a FAT exists, the computer will update the FAT whenever data is written, erased or moved within the device. Knowing the use and format of FAT, device software interacts with the user to read and decode the FAT and display the information from the FAT in response to the depression of buttons by the user.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A portable memory device comprising:
a) a housing;
b) a display on the housing, capable of exhibiting a changeable array of directories, sub-directories and file names in the form of symbols and alphanumeric characters;
c) an optional non-volatile flash memory within the housing capable of storing digital information in files having directories, sub-directories and file names associated therewith;
d) an attachment interface to enable communication with at least one host appliance;
e) an optional additional attachment interface for connection to a memory card;
f) a controller for exhibiting on the display one or more of the directories, sub-directories and file names within the optional non-volatile flash memory, or within a memory card attached to the optional additional attachment interface;
g) at least one switch on the housing for scrolling through a list of directories, sub-directories and file names within the optional memory or within a memory card attached to the optional additional attachment interface; and wherein at least one of the non-volatile flash memory and the additional attachment interface is present; and
h) a rechargeable battery electrically connecting the display with the controller.

2. The portable memory device of claim 1 further comprising battery charging circuitry electrically connecting the battery with the attachment interface.

3. The portable memory device of claim 1 wherein the additional attachment interface for connection to a memory card is present.

4. The portable memory device of claim 1 wherein the additional attachment interface for connection to a memory card is absent.

5. The portable memory device of claim 1 wherein the non-volatile flash memory is present.

6. The portable memory device of claim 1 wherein the non-volatile flash memory is absent.

7. The portable memory device of claim 1 wherein both the non-volatile flash memory and the additional attachment interface for connection to a memory card are present.

8. The portable memory device of claim 2 further comprising a memory card attached to the additional attachment interface.

9. The portable memory device of claim 1 comprising a plurality of switches on the housing for scrolling through a list of directories, subdirectories and file names within the memory or within a memory card optionally attached to the additional attachment interface.

10. The portable memory device of claim 1 wherein the at least one switch comprises at least one button switch.

11. The portable memory device of claim 1 wherein the attachment interface comprises a USB connector.

12. The portable memory device of claim 1 further comprising a battery for powering the display and the controller.

13. The portable memory device of claim 1 wherein the attachment interface is retractable into and out of the housing.

14. The portable memory device of claim 1 wherein the attachment interface is pivotally retractable into and out of the housing.

15. The portable memory device of claim 1 wherein the additional attachment interface for connection to a memory card is present; wherein the additional attachment interface and is positioned at one end of the housing and the attachment interface is positioned at an opposite end of the housing.

16. The portable memory device of claim 1 wherein the additional attachment interface for connection to a memory card is present; wherein the additional attachment interface is positioned at one end of the housing and the attachment interface is positioned at an adjacent side of the housing.

17. The portable memory device of claim 1 wherein the controller comprises a function for facilitating the copying of stored digital information in files either in the non-volatile flash memory or a memory card attached to the additional attachment interface.

18. The portable memory device of claim 1 wherein the controller comprises a file reading function for reading stored file attributes of files either in the non-volatile flash memory or a memory card attached to the additional attachment interface.

19. The portable memory device of claim 1 comprising a mode select switch, a pair of scroll switches, and an accept switch.

20. The portable memory device of claim 1 comprising an additional attachment interface for connection to a memory card; a plurality of button switches on the housing for scrolling through a list of file names within the memory or within a memory card optionally attached to the additional attachment interface; wherein the plurality of button switches comprise a mode select switch, a pair of scroll switches, and an accept switch; the attachment interface comprises a USB connector which is retractable into and out of the housing; and further comprising a battery for powering the display and the controller.

21. A method for identifying the file names in a portable memory device which comprises:
I.) providing a portable memory device comprising:
a) a housing;
b) a display on the housing, capable of exhibiting a changeable array of directories, sub-directories and file names in the form of symbols and alphanumeric characters;
c) an optional non-volatile flash memory within the housing capable of storing digital information in files having directories, sub-directories and file names associated therewith;
d) an attachment interface to enable communication with at least one host appliance;
e) an optional additional attachment interface for connection to a memory card;
f) a controller for exhibiting on the display one or more of the directories, sub-directories and file names within the optional non-volatile flash memory, or within a memory card attached to the optional additional attachment interface;
g) at least one switch on the housing for scrolling through a list of directories, sub-directories and file names within the optional memory or within a memory card attached to the optional additional attachment interface; and wherein at least one of the non-volatile flash memory and the additional attachment interface is present; and
h) a rechargable battery electrically connecting the display with the controller; and
II) observing the display while scrolling through a list of file names within the memory or within a memory card optionally attached to the additional attachment interface with the at least one switch on the housing.

22. The portable memory device of claim 21 further comprising battery charging circuitry electrically connecting the battery with the attachment interface.
